(19) United States
(12) Patent Application Publication
(10) Pub. No.: US 2023/0098479 A1
(43) Pub. Date: Mar. 30, 2023

(54) OBSCURING DATA COLLECTED FROM CONNECTED VEHICLES

(71) Applicant: Ford Global Technologies, LLC, Dearborn, MI (US)

(72) Inventors: Xingping Chen, Troy, MI (US); Jeremy Lerner, Southfield, MI (US); Jochen Schubert, Farmington Hills, MI (US); Scott Huggins, Novi, MI (US); Mohammad Abouali, Canton, MI (US)

(73) Assignee: Ford Global Technologies, LLC, Dearborn, MI (US)

(21) Appl. No.: 17/487,412

(22) Filed: Sep. 28, 2021

(51) Int. Cl. H04W 12/02; H04W 12/64; H04W 12/61; G01S 19/39

(52) U.S. Cl. CPC H04W 12/02; H04W 12/64; H04W 12/61; G01S 19/396; H04W 84/04

(57) ABSTRACT

As a computing device travels on a trip from a starting location to a destination location, geographic coordinates are captured and stored. The geographic coordinates are tested against an obscuring condition to determine a portion of the geographic coordinates that satisfy the obscuring condition. Based on the determined portion of geographic coordinates satisfying the obscuring condition, altering the geographic coordinates in the determined portion of the geographic coordinates to reduce their precision or accuracy. The computing device transmits the altered geographic coordinates and the geographic coordinates that did not satisfy the obscuring condition.

### BACKGROUND

Vehicle computers and mobile devices within vehicles often run software that collects and forwards travel-related data to a data collection service. Travel-related data usually includes, among other things, locations and corresponding times captured during travel. The data collection service receives and stores the travel data from the vehicles, and the aggregate travel data from many vehicles or mobile devices may have practical value. Aggregate travel data can be used for traffic analysis, characterizing roads in a road network, supplementing the artificial intelligence of an automated driving system, improving road navigation systems, and so forth.

Along with the many beneficial uses of aggregated travel data come privacy and security concerns. Travel-related data reported from a vehicle may also have information about a vehicle, a driver, or other metadata that may be considered private or sensitive. Even if personally identifiable information is anonymized from travel-related data before its aggregation, it can be difficult to guarantee that personally identifiable information cannot be inferred from the travel data as a whole. Data mining techniques combined with large databases of diverse personally identifiable information can potentially be used to infer the identities of specific persons in aggregated travel data and thus link specific persons to specific travel data, even if that travel data has been theoretically anonymized in isolation.

The reporting of travel-related data has been recognized as a privacy and security concern. In some places, privacy rules reflect a consensus that people prefer not to have it known where they have been and when. Consequently, most software that reports and collects travel-related data for aggregation and long-term use usually removes personally identifiable information or applies some means for anonymization. Nonetheless, prior techniques for anonymizing travel-related data have not protected some sensitive aspects of users' travel data.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a system for collecting travel data according to one or more embodiments.

FIG. 2 shows an overview of steps performed by example components according to one or more embodiments.

FIG. 3 shows an example of captured trip location data according to one or more embodiments.

FIG. 4 shows an example of identifying locations that are to be obscured according to one or more embodiments.

FIG. 5 shows an example of partially obscuring some trip locations according to one or more embodiments.

FIG. 6 shows an example of obscuring locations based on the origin and destination of a trip, according to one or more embodiments.

FIG. 7 shows an example of obscuring locations based on predefined geofence areas, according to one or more embodiments.

FIG. 8 shows truncation points according to one or more embodiments.

FIG. 9 shows details of a computing device according to one or more embodiments.

### DETAILED DESCRIPTION

### Overview

Embodiments discussed below relate to partially obscuring travel data. As a computing device travels on a trip from a starting location to a destination location, geographic coordinates are captured and stored. The geographic coordinates are tested against an obscuring condition to determine a portion of the geographic coordinates that satisfy the obscuring condition. Based on the determined portion of geographic coordinates satisfying the obscuring condition, the geographic coordinates in the determined portion of the geographic coordinates are altered to reduce their ability to identify personal information about a driver. The computing device transmits the altered geographic coordinates and the unaltered geographic coordinates that did not satisfy the obscuring condition.

### Embodiments

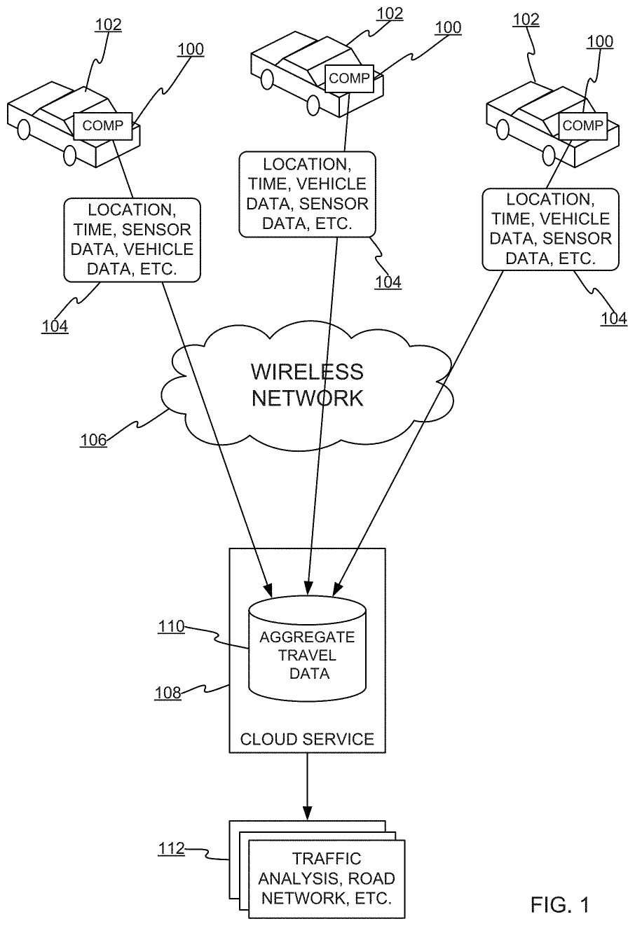

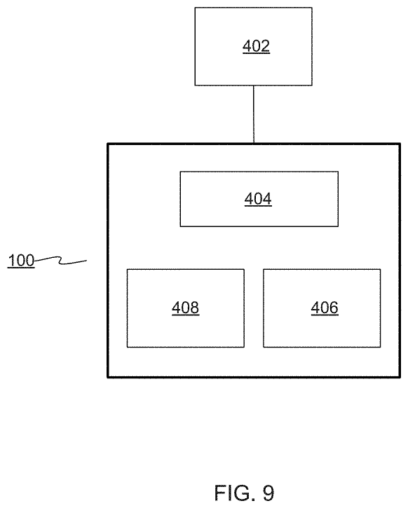

FIG. 1 shows a system for collecting travel data according to one or more embodiments. Computing devices 100 are associated with and travel with vehicles 102. A computing device 100 may be an on-board general-purpose computer incorporated into a vehicle 102 and performing various vehicle functions, or it may be a mobile device carried by a user within a vehicle 102. Details of a computing device 100 are provided below with reference to FIG. 9. The computing devices 100 may run software configured to collect travel data 104 and transmit the travel data 104, via a wireless network 106 (for example, cellular or satellite), to a cloud service 108, for instance a cloud storage service, which stores aggregate travel data 110 received from the computing devices 100.

The travel data includes locations of the vehicles 102 captured by the computing devices 100 as they travel and then transmitted to the cloud service 108. The travel data may also include other information such as timestamps of the respective vehicle locations (that is, the times when the location data is captured), vehicle information, sensor information (for example, pictures of road surfaces or vehicle surroundings, vehicle speeds, etc.), driver information, and so forth. In some embodiments, the travel data 104 is anonymized before being transmitted by the computing devices 100. That is, personally identifiable information may be scrubbed from the travel data 104 before transmission to the cloud service 108. For example, identities of persons or vehicles may be replaced with hashes of travel data or ephemeral random identifiers, either allowing travel data to be associated with a single anonymous person or vehicle. In one embodiment, a travel data 104 record from a vehicle may include only a vehicle location and some identifier such as an identifier of a discrete trip, an identifier of a vehicle, etc.

The aggregate travel data 110 is stored by the cloud service 108. The cloud service 108 may itself make use of the aggregate travel data 110. The cloud service 108 may provide the aggregate travel data 110 to other applications 112, for example, a road network database, a traffic analysis system, an autonomous-driving support system, and so forth.

As noted above, even if the travel data is anonymized by omitting or replacing personally identifiable information, it may be possible to infer identities of persons within the aggregate travel data 110, and, therefore, the places that identified people travel to and from. For example, trips frequently beginning from a specific home address can be used to associate those locations with a small possible number of computing devices 100, vehicles 102, and households, effectively de-anonymizing the travel data 104. Embodiments described herein may determine to partially obscure (for example, reduce the accuracy or precision of) some locations within the travel data that are determined to meet various conditions such as being near the beginning or ending of trips, being within predefined geographical regions (geofence regions), or others. A geofence region may be at least in part defined prior to the trip starting. Further, the geofence region may be based at least in part on user input (for example, a region selected by a user), automatically defined based on vehicle operation (for example, based on one or both of the engine starting and/or stopping) defined based on crowd sourcing, defined based on road construction, and/or based on a property boundary (for example, a military base, a campus, etc.).

In the case of a cloud service that uses the travel data to analyze or characterize a road network, for example, it is likely that the reduced precision or accuracy of small portions of aggregate travel data 110 will be compensated for by non-obscured location data at or near the obscured locations. That is to say, for a given trip/vehicle, even if there are areas for the given trip/vehicle that are determined to require location obscuring for portions of that trip/vehicle, those areas may not require location obscuring for other trips/vehicles and therefore, overall, there may be an adequate amount of accurate location data within those areas. For example, if locations at an origin area or destination area of one trip are obscured, locations of other trips that merely pass through those areas may not be obscured (as used herein, “destination” means a trip endpoint, regardless of whether the endpoint was set in advance or whether the endpoint was merely the point where a trip ended). Or, even if one vehicle is associated with a geofenced obscuring area, and therefore, provides less-accurate or less-precise locations for the geofenced area, other vehicles may not have a geofence for that area and may therefore potentially provide accurate locations for that area. Not only may the aggregate travel data 110 be accurate and precise on the whole despite partial location obscuring, as discussed below, locations whose fidelity has been reduced may be flagged to allow those locations to be specially handled by software making use of the aggregate travel data 110.

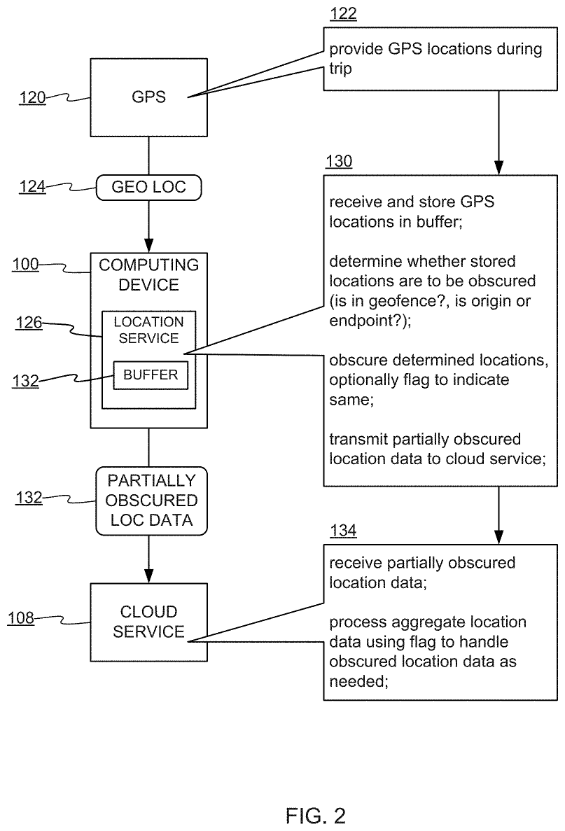

FIG. 2 shows an overview of steps performed by example components according to one or more embodiments. A Geographical Positioning System (GPS) module 120 of a computing device 100 may perform step 122 of providing geographic locations 124 to the computing device 100, for example periodically during a trip. Other means may be used to obtain the geographic locations 124, for example cellular triangulation. Moreover, the geographic locations 124 may be provided by an intermediary software component.

A location service 126 executes on the computing device 100. The location service 126 may be implemented in many ways. The location service 126 may be an application dedicated to collecting and reporting location data. The location service 126 may be an operating system component configured to provide location data to any applications executing on the computing device 100. The location service 126 may be a software shim operating between the GPS module 120 and some other location-using application executing on the computing device 100 or elsewhere. The location service 126 may be a component of a road-reporting system where vehicles provide location data to a cloud service that characterizes roads in a road network. The location service 126 may be any application that obtains geographic locations 124 and transmits them via the wireless network 106. Regardless of its other functions or whether it is a system component or application, the location service 126 may perform step 130 of partially obscuring some of the geographic locations 124 received from the GPS module 120.

Step 130 includes receiving the geographic locations 124. In some embodiments, for example when it cannot be immediately determined whether to obscure a given geographic location (for example, determining a destination of a trip in progress), the geographic locations may be cached in a buffer 132. In embodiments where it can be immediately determined whether a geographic location needs to be obscured (for example, a user may have activated an “obscuring mode” during which all captured locations are obscured), the geographic locations 124 may not need to be cached. Step 130 further includes determining whether geographic locations 124 are to be obscured. This may involve, for example, determining whether a given geographic location 124 is within an area associated with an origin of a trip, is within an area associated with a destination of a trip, or is within a geofenced area, to name some examples. Any method for defining location-obscuring areas may be used. In other words, many types of conditions may be used to define when to perform obscuring or to define which geographic locations are to be obscured. Step 130 also involves obscuring the geographic locations 124 that have been determined to need obscuring. That is, whichever geographic locations 124 are determined to need obscuring, any of a variety of techniques (discussed in detail below) may be used to obscure those geographic locations 124. In addition to obscuring those determined locations, the obscured locations may be flagged to inform downstream users that the locations have been obscured. Finally, step 130 involves transmitting the partially obscured location data 132 to the cloud service 108. This transmission may be in real-time or near real-time, periodic (for example, daily or weekly), or based on a trigger (for example, at the conclusion of a trip). Location data not obscured due to not falling within an obscuring area may also be transmitted with it is original accuracy and precision.

At step 134 the cloud service 108 receives the partially obscured location data 132. In analyzing or otherwise using the aggregated location data, the cloud service 108 may specially handle any locations flagged as having been obscured. For example, such locations might be disregarded by some algorithms, they might be given less weight if used as training data, and so on. Nonetheless, obscured locations may have practical value for many applications. For example, aggregate latitudes and longitudes within a given area, even when truncated to two digits, may be relevant for determining usage of some ADAS (advanced driver-assist systems) features such as automated parking.

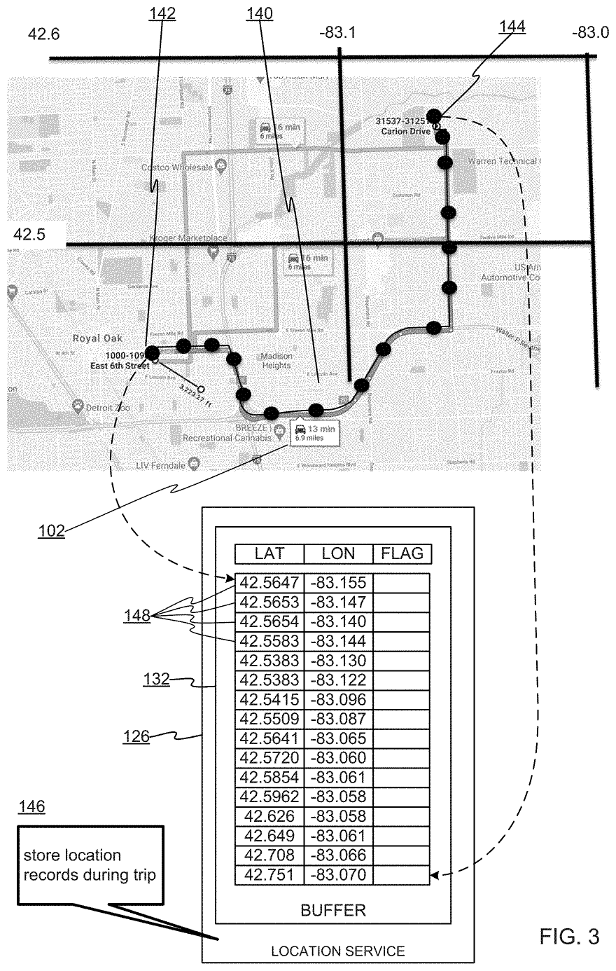

FIG. 3 shows an example of captured trip location data according to one or more embodiments. In this example, a vehicle 102 travels a trip 140 from an original location 142 to a destination location 144. The map in FIG. 3 shows the trip 140 as well as latitude and longitude lines. As discussed above, in some embodiments, as the vehicle 102 travels, the location service 126 may perform a step 146 of storing trip locations 148 of the vehicle in the buffer 132. The locations 148 may be in the form of latitude and longitude numbers, although any geocoordinate system may be used, for example geohashes, as discussed below.

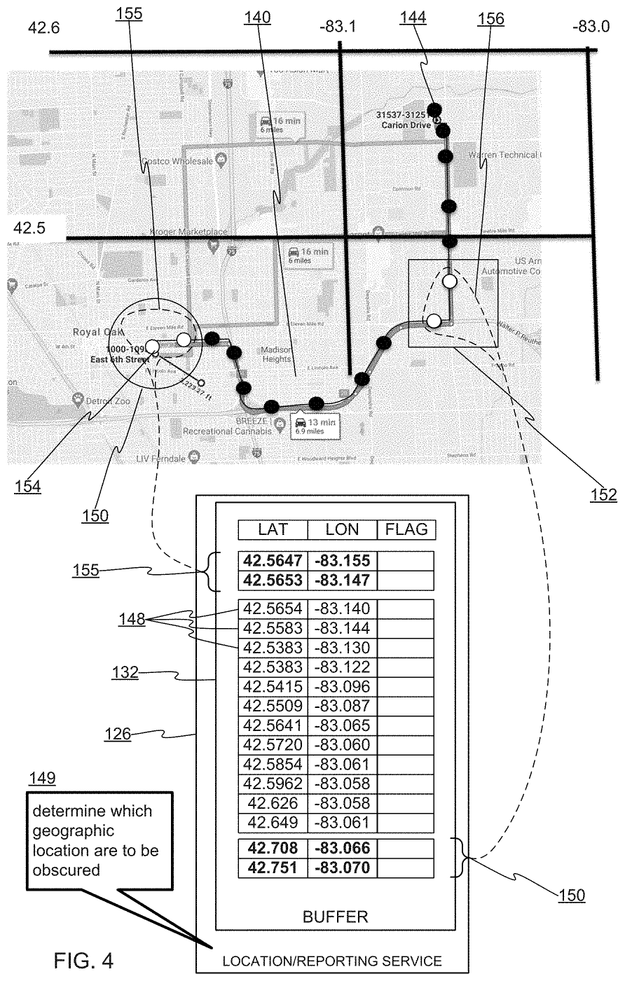

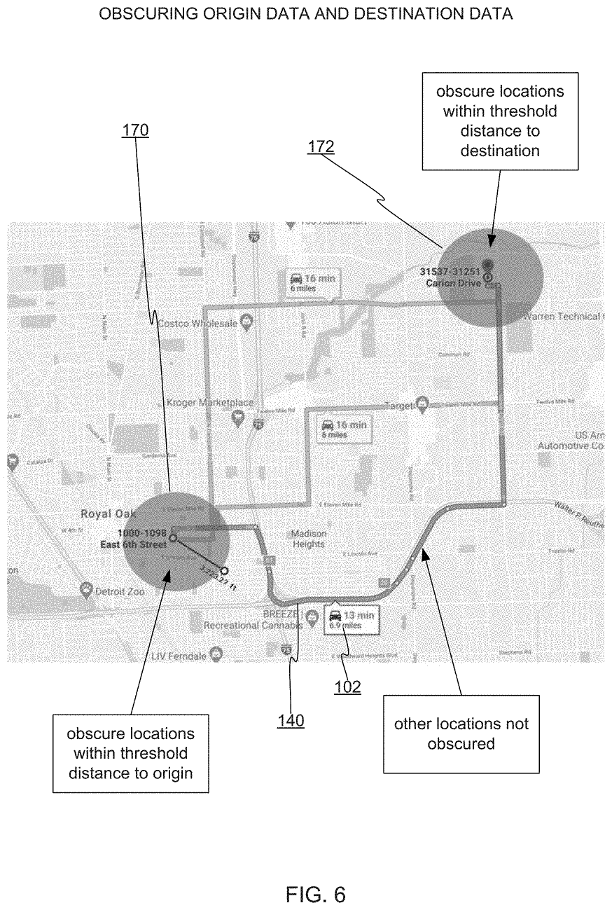

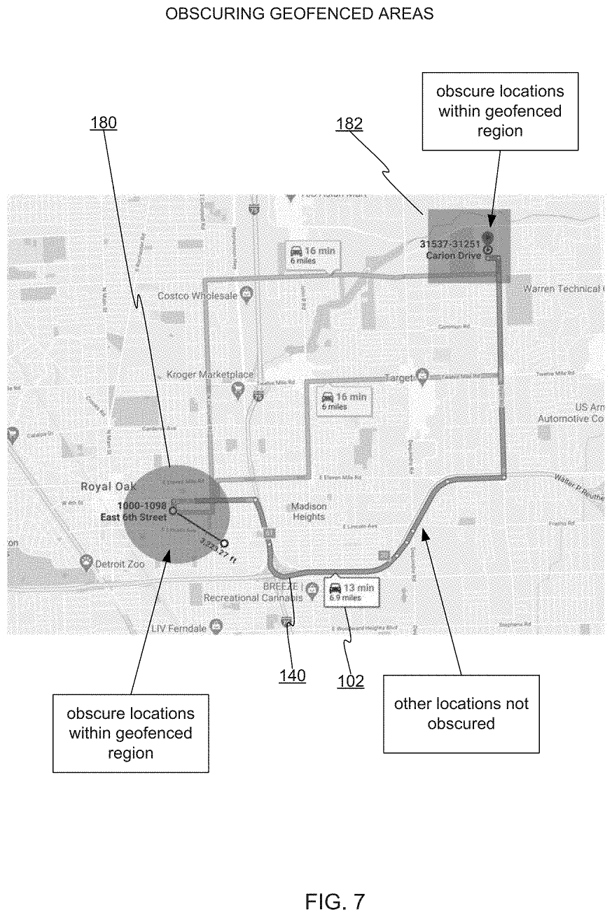

FIG. 4 shows an example of identifying locations 148 that are to be obscured according to one or more embodiments. As discussed above, some of the locations where vehicles have driven can be sensitive information. The location service 126 performs a step 149 of determining which trip locations 148 are to be obscured based on one or more obscuring conditions. Obscuring conditions are conditions that trip locations 148 can be tested against to determine which trip locations 148 are to be obscured. Any obscuring conditions may be used that can select a subset of locations for obscuring. That is, any type of condition that can distinguish one location from another may serve as an obscuring condition. For example, an obscuring condition may be one or more geofences. Any trip location 148 that the location service 126 determines falls within a geofence satisfies that obscuring condition (see FIG. 7 for examples) and is therefore selected for obscuring. As another example, an obscuring condition may be a trip origin area or a trip destination area. The location service 126 may determine whether trip locations 148 fall within areas respectively associated with an origin or destination of a trip (see FIG. 6 for examples of obscuring areas associated with an origin and destination). As another example, an obscuring condition might be a particular road or section of highway.

Obscuring conditions may be global, specific to individual users or vehicles, specific to individual trips, and so forth. A user may have one or more associated obscuring conditions that are applied to that user's captured trip locations. There may also be obscuring conditions that are applied to all users, or some that are applied to a subset of users.

In some embodiments, obscuring conditions may be managed by a cloud service that provides the obscuring conditions to the computing devices 100. For example, obscuring conditions may come from crowd-sourced data, where an obscuring condition is auto-applied to a location based on a threshold plurality of users having enabled obscuring for that location. Obscuring conditions may also be managed by the computing devices 100. In sum, the location service 126 may perform step 149 of determining which trip locations 148 of the trip 140 stored in the buffer 132 are to be obscured by determining which trip locations 148 satisfy one or more obscuring conditions.

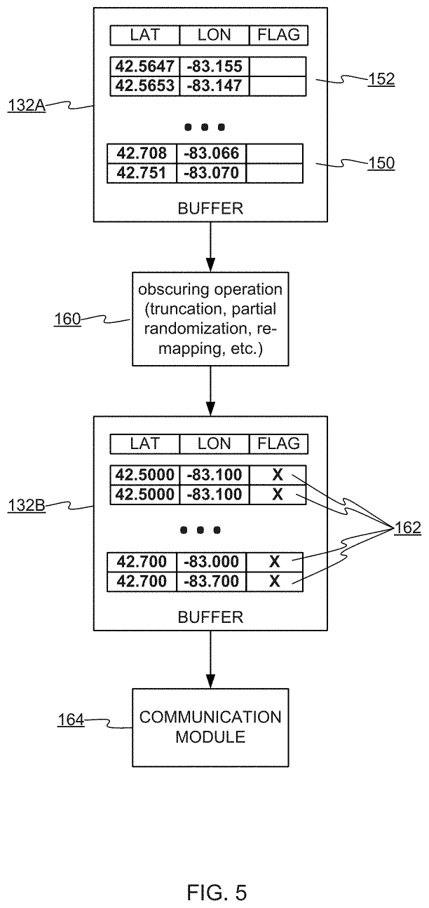

In the example of FIG. 4, the obscuring condition includes a first condition 150 and a second condition 152. The first condition 150 is a trip origin area and the second condition 152 is a geofence. The first condition 150 is dynamic in that the condition depends on a feature of the trip 140; the trip's origin. Assuming that the obscuring conditions are to be applied to each trip of the relevant vehicle, such as trip 140, the location service 126 first determines the origin location 154 among the trip locations 148 of the trip 140. An area (a circle, for example) around the origin location 154 serves as the first condition 150. The second condition 152 is a geofence (for example, a rectangle). To perform step 149, the location service 126 checks the trip locations 148 against the first condition 150; any trip locations that fall within the origin area are selected for obscuring. In the example of FIG. 4, first locations 155 are determined to meet the first condition 150 and are therefore selected for obscuring. As shown in FIG. 4, the first locations 155 are locations with coordinates (42.5647, −83.155) and (42.5653, −83.147). Further performing step 149, the location service 126 checks the trip locations 148 (possibly excluding locations already determined to need obscuring) to determine that second locations 156 meet the second condition 152. The second locations 156 are also selected for obscuring. As shown in FIG. 4, the second locations 156 are locations with coordinates (42.708, −83.066) and (42.751, −83.070). Techniques for obscuring are discussed with reference to FIG. 5 and elsewhere.

Regarding the buffer 132, as a vehicle 100 travels the trip 140, in some embodiments the location service 126 may accumulate the locations 148 into the buffer 132 where they are retained to be checked, partially obscured, and transmitted sometime after the trip has finished. Caching may be helpful because in some cases it may not be possible or desirable to determine whether a trip location needs to be obscured at the time when the trip location is captured. For example, it may not be possible to know whether which captured trip locations are near the destination because the destination may not be known until the trip has ended. Or, it may be desirable to periodically (for example daily) batch-process trip location data. Therefore, it may be helpful to store the trip locations 148 in the buffer 132 before obscuring them and transmitting them to the cloud service.

FIG. 5 shows an example of partially obscuring some trip locations 148 according to one or more embodiments. The initial buffer 132A contains the unobscured locations as previously captured from the GPS module 120. The location service 126 then performs an obscuring operation 160 on the first and second set of target locations 150, 152 that have been selected for obscuring. The obscuring may be performed when locations are determined to satisfy an obscuring condition, or they may be flagged for later obscuring. An objective of the obscuring operation 160 is to cause a target location to no longer indicate its initial accurate location yet still have some relation to its initial location. A location that has been obscured may be near its original location yet far enough away from its original location to avoid disclosing an origin or destination of a trip, for example. Another approach is to modify a location to indicate an area rather than a location (see the discussion of geohashing below). Any mathematical transform may be used that allows a vicinity of an original location to be indicated without revealing the original location. In the example shown in FIG. 5, the latitude and longitude of the target locations are obscured by truncating them to the nearest decimal. For example, original latitude 42.5647 is truncated to obscured latitude 42.5000.

While truncation is an effective and efficient technique, other obscuring techniques may be used. A location's coordinates may be truncated and also randomized A location may be moved in a random direction and a random distance (within some range of distance, for example half a mile to one mile). A coordinate may have its accuracy reduced by a rounding function (which will include at least some truncation). Any technique which reduces the granularity or accuracy of a coordinate will suffice.

Geohashing is another technique that may be used to reduce the granularity or accuracy of a location. With geohashing, some or all trip locations may be encoded as geohashes. A geohash of a vehicle location indicates that the vehicle was within a certain polygon (often a square). A geohash encoding of a location's coordinates indicates that a vehicle was in a specific area and the size of the area can be varied according to the geohash value, thus allowing location obscuring. Non-obscured locations may have precise geohashes, for example, on the order of several meters. Obscured locations may be geohashed to represent larger areas, for example several kilometers. The size of polygons for obscured locations may be specifically established so as to coincide with geographic features such as a town, neighborhood, subdivision, etc. As used herein, “coordinate” and “location” refer to traditional geographical coordinates as well as any encoding of a coordinate, including for example geohashes.

Regardless of the obscuring technique, the degree of reduced accuracy or precision may vary depending on factors such as the road density at the target location (higher road density may not require as much obscuring) or a geographic characteristic of the location (for instance, a neighborhood). In one embodiment, displaced locations may be “snapped” to a nearest road. In yet another embodiment, locations may be displaced with a simulated randomized drive, for example, a drive from the original location with random turns that travels within some range of distance. In another embodiment, there may be a grid of pre-defined global “snap-to” locations, and a location is obscured by setting it to the nearest snap-to location. In most cases, the obscured locations will be moved (or expanded, in the case of geohashes) based on their original locations and will remain near their original locations.

In addition to obscuring coordinates of target locations, the location service 126 may also set flags 162 for the respective target locations that have been obscured. Because other software will likely use the partially obscured location data, it may be helpful to allow software that consumes the aggregate travel data 110 which locations are original and which have been modified. Applications requiring high fidelity location data may disregard flagged locations. The modified buffer 132B contains the unmodified locations, the obscured locations from the first and second target sets, and, optionally, flags distinguishing the modified locations. The location service 126 transmits the modified locations to the cloud service 108 through a communication module 164 (for example a network stack or interface) of the computing device 100. It may be convenient to set the flags 162 when the respective target locations are selected for obscuring, which will allow the later obscuring operation 160 to know which locations to obscure.

Regarding the timing of transmission of partially obscured location data for a trip, in embodiments that obscure locations near a trip origin but not locations near a destination trip, the location data for a trip may be obscured and transmitted as soon as received, and locations may stop being obscured as soon as they pass out of the obscuring area around the origin. However, for embodiments that obscure locations near a trip destination, because the locations that are to be obscured may not be fully known until the trip has ended, it may be more convenient, as discussed above, to accumulate locations of a trip in the buffer, identify and modify the target locations within the buffer after the trip is complete, and then transmit the modified and unmodified locations for the trip. A batch approach may be used to allow many trips to be stored over time and then be periodically (for example, daily) processed and transmitted.

In addition to obscuring location data, it may be helpful to also obscure timestamps. In some embodiments, as a vehicle travels, timestamps are captured with the respectively captured locations of the vehicle. In addition to obscuring targeted locations, the timestamps for the target locations may also be obscured. Any technique to reduce the accuracy and/or granularity of a timestamp may be used, for example, truncation, partial randomization, addition of random noise, or others.

FIG. 6 shows an example of obscuring locations based on the origin and destination of a trip, according to one or more embodiments. FIG. 6 shows the same example trip 140 shown in FIGS. 4 and 5. In the example of FIG. 6, an origin obscuring area 170 is implemented by the location service 126 as the area within a given distance (for instance, 0.6 miles) of the trip's origin as determined by the location service 126. Similarly, a destination obscuring area 172 is defined by the location service 126 as the locus of locations within a given distance of the trip's destination as determined by the location service 126. Any locations of the trip 140 that fall within the origin obscuring area 170 or the destination obscuring area 172 are obscured as discussed above, perhaps including setting flags and obscuring timestamps. The beginning of the trip 140 may be determined, for example, by receiving new locations after a threshold amount of time, detecting starting of the vehicle, receiving data from vehicle sensors, receiving a signal from a navigation application, etc. The end of the trip 140 may be determined, for example, by receiving a message from another software module, by detecting the vehicle being turned off, determining a lack of new locations from the GPS module for a threshold amount of time, and so on.

FIG. 7 shows an example of obscuring locations based on predefined geofence areas, according to one or more embodiments. FIG. 7 shows the same example trip 140 shown in FIGS. 4 and 5. As noted above, areas to be obscured may be geofenced regions that are defined before a trip begins. In the example of FIG. 7, when the trip begins, there is a first geofence 180 and a second geofence 182. When the trip is complete, the location service 126 determines which locations stored in the buffer are within any predefined geofenced areas, for example, the first geofence 180 or the second geofence 182. Any locations determined to be within the geofences are obscured in the buffer as discussed above (which might include setting flags and obscuring timestamps) and are then transmitted to the cloud service. If only geofences are used and not origin/destination detection, then locations may be obscured and transmitted on-the-fly without retaining all locations of a trip before the trip ends.

In one embodiment, the location service 126 executing on a computing device 100 maintains a local set of geofences which are applied to any trips captured for the vehicle. In another embodiment, geofences are obtained from a cloud service by the location service 126.

Geofences may be manually defined by a user or automatically defined. A user may define a geofence with an interactive mapping application that allows a user to interactively define geographic areas (geofences). A geofence may instead be defined by instructing the location service 126 to automatically detect common origins and destinations and generate geofences for them. This approach may also be automatic; the location service 126 may automatically detect common origins, destinations, or visitation locations (for example, where a vehicle stops to drop off a passenger) and create respective geofences at those locations. Geofences may also be generated by one or more cloud services using any of the techniques mentioned above, and, as noted above, the generated geofences may be provided to a vehicle's computing device for use by its location service 126. Using this approach can also allow geofences to be applied to a group of computing devices. For example, there may be a sensitive area (for example a military base) or an area changing (for example road construction) where it is preferable to have the location data of all participating vehicles obscured. In sum, the functionality for managing geofences can be at the computing devices, at a cloud service, or both.

Other obscuring techniques may be used. For example, geofences may or may not be centered over a vehicle's true origin or destination. That is, the geofences and obscuring regions may have a randomized offset and variable range from the true origins and destinations so as to prevent analysis techniques that may attempt to determine a set of candidate de-anonymized origins and destinations of a trip, thus maintaining the user's privacy. Consider also that if all points outside of a radius are obscured, then it can be possible to find the center of the circle with sufficient data as the vehicle leaves the circle. Thus, another obscuring technique is to slightly grow or shrink the radius for different trips to add randomization. That is, the radius could be 0.9 miles on day one, and 1.1 miles on day two. In addition, the center may be randomly moved by 0.1 miles every day, which will make it difficult to determine the center of the radius.

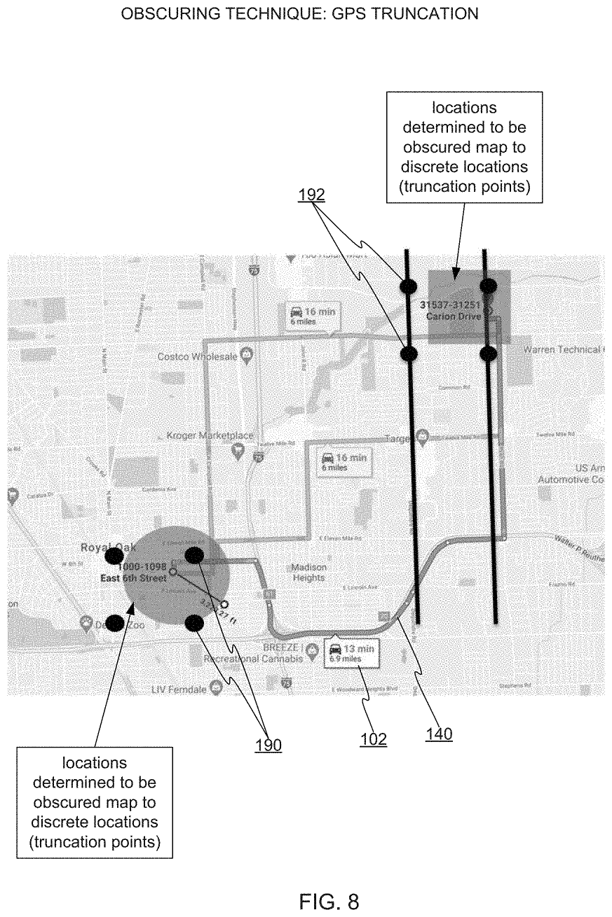

FIG. 8 shows truncation points 190, 192 according to one or more embodiments. FIG. 8 shows a first obscuring area 194 and a second obscuring area 196, which may be pre-defined geofences, areas around an origin and destination, or others. The truncation points 190 near the first obscuring area 194 are coordinates with no decimal component smaller than, for example, tenths. For example, a truncation point might be (42.5000, −83.1000). Any captured trip locations in either obscuring area will, when truncated, map to the truncation points. Any trip locations in the first obscuring area 194 might map to any of the four nearby truncation points 190. Any trip locations in the second obscuring area 196 will, when truncated, map to any of the four nearby truncation points 192.

FIG. 9 shows details of a computing device 100 according to one or more embodiments. The technical disclosures herein will suffice for programmers to write software, and/or configure reconfigurable processing hardware (e.g., field-programmable gate arrays (FPGAs)), and/or design application-specific integrated circuits (ASICs), etc., to run on the computing device 200 to implement any of the features or embodiments described herein.

The computing device 100 may have one or more displays 402, a network interface 404 (or several), as well as storage hardware 406 and processing hardware 408. The processing hardware 408 may be a combination of any one or more: central processing units, graphics processing units, analog-to-digital converters, bus chips, FPGAs, ASICs, Application-specific Standard Products (ASSPs), or Complex Programmable Logic Devices (CPLDs), etc. The storage hardware 406 may be any combination of magnetic storage, static memory, volatile memory, non-volatile memory, optically or magnetically readable matter, etc. The meaning of the term “computer-readable storage” and “storage hardware”, as used herein does not refer to signals or energy per se, but rather refers to physical apparatuses and states of matter. The hardware elements of the computing device 100 may cooperate in ways well understood in the art of machine computing. In addition, input devices may be integrated with or in communication with the computing device 100. The computing device 100 may have any form-factor or may be used in any type of encompassing device.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such labels or phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method performed by a computing device comprising storage hardware and processing hardware, the method comprising:
as the computing device travels on a trip from a starting location to a destination location, storing geographic coordinates of the computing device captured during the traveling;
testing the geographic coordinates against an obscuring condition to determine a portion of the geographic coordinates that satisfy the obscuring condition;
based on the determined portion of geographic coordinates that satisfy the obscuring condition, altering the geographic coordinates in the determined portion of the geographic coordinates, wherein the altering comprises reducing the precision or accuracy of the geographic coordinates in the determined portion of geographic coordinates; and
transmitting, from the computing device via a wireless network, (i) the altered geographic coordinates, and (ii) the geographic coordinates that did not satisfy the obscuring condition.

2. The method according to claim 1, wherein the geographic coordinates further comprise respective timestamps, and wherein the altering the geographic coordinates in the determined portion of the geographic coordinates further comprises obscuring the corresponding timestamps.

3. The method according to claim 1, wherein the obscuring condition comprises a geographic area based on an origin or destination of the trip.

4. The method according to claim 1, wherein the obscuring condition comprises a geofenced area, and wherein the geofenced area is defined before the trip begins.

5. The method according to claim 1, wherein the geographic coordinates comprise latitudes and longitudes, and wherein the altering comprises truncating or reducing the precision of the longitudes and the latitudes of the geographic coordinates in the determined portion of the geographic coordinates.

6. The method according to claim 1, wherein the obscuring condition comprises a region that is (i) randomly sized and/or (ii) randomly offset from the starting location or destination location.

7. The method according to claim 1, wherein the geographic coordinates comprise latitudes and longitudes, and wherein the altering comprises reducing the precision of the latitudes and longitudes in the determined portion of the geographic coordinates.

8. The method according to claim 1, wherein the geographic coordinates comprise latitudes and longitudes, and wherein the altering comprises at least partially randomizing the latitudes and longitudes in the determined portion of the geographic coordinates.

9. A computing device comprising:
processing hardware;
a Global Positioning System (GPS) module;
storage hardware storing instructions configured to be executed by the processing hardware to perform a process, the process comprising:
receiving GPS coordinates from the GPS module while the computing device is traveling on a trip, and storing the GPS coordinates in the storage hardware;
determining, according to the GPS coordinates of the trip and according to a defined geographic area, which of the GPS coordinates of the trip are within the defined geographic area, wherein a first portion of the GPS coordinates are determined to be within the geographic area, and wherein a second portion of the GPS coordinates are determined to not be within the defined geographic area;
based on determining that the GPS coordinates in the first portion of GPS coordinates are within the defined geographic area, reducing the accuracy or precision of the GPS coordinates in the first portion of GPS coordinates;
based on determining that the GPS coordinates in the second portion of GPS coordinates are not within the defined geographic area, determining to not reduce the accuracy or precision of the GPS coordinates in the second portion of GPS coordinates; and
transmitting, via a wireless network, the reduced GPS coordinates and the non-reduced GPS coordinates in the second portion of GPS coordinates.

10. The computing device according to claim 9, wherein the defined geographic area comprises a geofence defined at least in part prior to the trip starting, based at least in part on user input, automatically based on vehicle operation, based on crowd sourcing, defined based on road construction, or based on a property boundary.

11. The computing device according to claim 9, wherein the GPS locations include an origin GPS location corresponding to the start of the trip and a destination GPS location corresponding to the start of the trip, and wherein the defined geographic area is defined according to the origin GPS location or the destination GPS location.

12. The computing device according to claim 9, wherein the reducing comprises reducing the precision of the GPS coordinates in the first portion of GPS coordinates.

13. The computing device according to claim 12, wherein the GPS coordinates are encoded as respective geohashes, and wherein reducing the precision of the GPS coordinates in the first portion of GPS coordinates corresponding increases the sizes of geographic areas represented by the respective geohashes.

14. The computing device according to claim 9, wherein the first and second portions of GPS coordinates are transmitted to a cloud service that collects GPS coordinates from other computing devices, and wherein the other computing devices are configured to execute duplicates of the instructions in the storage hardware.

15. A method performed by a computing device, the computing device incorporated in a vehicle, the method comprising:
while the vehicle is traveling a trip from an origin location to a destination location, receiving Global Positioning System (GPS) coordinates of the vehicle;
storing the GPS coordinates in a buffer;
after the vehicle is done traveling the trip, based on the GPS coordinates in the buffer, selecting a portion of the GPS coordinates in the buffer;
reducing the accuracy or precision of the selected GPS coordinates in the buffer, wherein GPS coordinates in the buffer that are not selected do not have their accuracy or precision reduced; and
transmitting the reduced and non-reduced GPS coordinates in the buffer from the computing device via a wireless network.

16. The method according to claim 15, wherein the GPS coordinates in the buffer comprise respective timestamps.

17. The method according to claim 16, further comprising reducing the accuracy or precision of the timestamps of the selected GPS locations in the buffer, wherein the timestamps of the non-selected GPS coordinates in the buffer do not have their accuracy or precision reduced.

18. The method according to claim 15, wherein the selecting the portion of GPS coordinates in the buffer comprises determining that the GPS coordinates meet a selection condition, the selection condition comprising one or more of: being within a threshold distance of the origin location or destination location or being within a geographic area that is delineated prior to the trip.

19. The method according to claim 15, wherein the GPS coordinates in the buffer comprises respective flags, the method further comprising setting the flags of the selected GPS coordinates and not setting the flags of the non-selected GPS coordinates.

20. The method according to claim 15, wherein the reducing the accuracy or precision of the selected GPS coordinates comprises randomly permuting the selected GPS coordinates.
